(19) United States
(12) Patent Application Publication
(10) Pub. No.: US 2023/0318034 A1
(43) Pub. Date: Oct. 5, 2023

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si, Gyeonggi-do (KR)

(72) Inventors: Dahyun KIM, Yongin-si (KR); Minseo KIM, Yongin-si (KR); Sanghyung KIM, Yongin-si (KR); Sanghoon KIM, Yongin-si (KR); Hyejin PARK, Yongin-si (KR); Myungheui WOO, Yongin-si (KR); Bokyung RYU, Yongin-si (KR); Tae Jin LEE, Yongin-si (KR)

(21) Appl. No.: 18/012,887

(22) PCT Filed: Feb. 16, 2022
(86) PCT No.: PCT/KR2022/002285

§ 371 Date: Jun. 5, 2023

(30) Foreign Application Priority Data
Mar. 22, 2021 (KR) 10-2021-0036687

(51) Int. Cl. H01M 10/0567

(52) U.S. Cl. CPC H01M 10/0567

(57) ABSTRACT

Provided are an electrolyte for a rechargeable lithium battery and a rechargeable lithium battery including same, the electrolyte including a non-aqueous organic solvent, a lithium salt, and an additive, wherein the additive is a composition including a first compound represented by Chemical Formula 1 and a second compound represented by Chemical Formula 2.

Details of Chemical Formulas 1 and 2 are the same as those described in the specification.

### TECHNICAL FIELD

This disclosure relates to an electrolyte for a rechargeable lithium battery and a rechargeable lithium battery including the same.

### BACKGROUND ART

A rechargeable lithium battery may be recharged and has three or more times as high energy density per unit weight as a conventional lead storage battery, nickel-cadmium battery, nickel hydrogen battery, nickel zinc battery and the like. It may be also charged at a high rate and thus, is commercially manufactured for a laptop, a cell phone, an electric tool, an electric bike, and the like, and researches on improvement of additional energy density have been actively made.

Such a rechargeable lithium battery is manufactured by injecting an electrolyte into a battery cell, which includes a positive electrode including a positive electrode active material capable of intercalating/deintercalating lithium ions and a negative electrode including a negative electrode active material capable of intercalating/deintercalating lithium ions.

Particularly, the electrolyte uses an organic solvent in which a lithium salt is dissolved, and such an electrolyte is important in determining stability and performance of a rechargeable lithium battery.

LiPF₆, which is most commonly used as a lithium salt of the electrolyte, has a problem of accelerating the depletion of the solvent and generating a large amount of gas by reacting with the organic solvent of the electrolyte. When LiPF₆ decomposes, LiF and PF₅ are produced, which causes electrolyte depletion in the battery, resulting in high-temperature performance degradation and poor safety.

Accordingly, there is a demand for an electrolyte with improved safety without performance deteriorate even at high-temperature condition.

### DISCLOSURE

### Technical Problem

An embodiment provides an electrolyte for a rechargeable lithium battery having improved thermal stability.

Another embodiment improves a rechargeable lithium battery with improved cycle-life characteristics, high-temperature safety, and high-temperature reliability by applying the electrolyte, and in particular, improved high-temperature storage characteristics and swelling characteristic by reducing gas generation and resistance increase rate during high-temperature storage or when exposed to internal short-circuit conditions.

### Technical Solution

An embodiment of the present invention provides an electrolyte for a rechargeable lithium battery including a non-aqueous organic solvent, a lithium salt, and an additive, wherein the additive is a composition including a first compound represented by Chemical Formula 1 and a second compound represented by Chemical Formula 2.

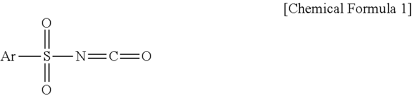

In Chemical Formula 1,

Ar is a substituted or unsubstituted C6 to C30 aryl group or a substituted or unsubstituted C2 to C30 heterocyclic group;

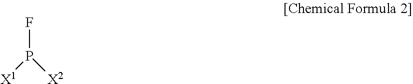

wherein, in Chemical Formula 2,

X¹ and X² are each independently a halogen or —O—L¹—R¹, and

at least one of X¹ to X² is —O—L¹—R¹,

wherein L¹ is a single bond or a substituted or unsubstituted C1 to C10 alkylene group, and

R's are each independently a cyano group (—CN), a difluorophosphite group (—OPF₂), a substituted or unsubstituted C1 to C10 alkyl group, a substituted or unsubstituted C2 to C10 alkenyl group, a substituted or unsubstituted C2 to C10 alkynyl group, a substituted or unsubstituted C3 to C10 cycloalkyl group, a substituted or unsubstituted C3 to C10 cycloalkenyl group, a substituted or unsubstituted C3 to C10 cycloalkynyl group, or a substituted or unsubstituted C6 to C20 aryl group, and

when X¹ and X² are simultaneously —O—L¹—R¹,

R¹s are each independently present, or

two R¹s are linked to each other to form a substituted or unsubstituted monocyclic or polycyclic aliphatic heterocycle or a substituted or unsubstituted monocyclic or polycyclic aromatic heterocycle.

The composition may include the first compound and the second compound in a weight ratio of 0.1:1 to 10:1.

The composition may include the first compound and the second compound in a weight ratio of 0.5:1 to 5:1.

The first compound may be included in an amount of 0.1 to 5.0 parts by weight based on 100 parts by weight of the electrolyte for the rechargeable lithium battery.

The second compound may be included in an amount of 0.1 to 5.0 parts by weight based on 100 parts by weight of the electrolyte for the rechargeable lithium battery.

The composition may be included in an amount of 0.2 to 10 parts by weight based on 100 parts by weight of the electrolyte for the rechargeable lithium battery.

The first compound may be represented by Chemical Formula 1A.

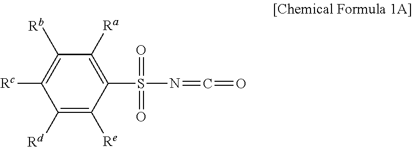

R^{a}, R^{b}, R^{b}, R^{d}, and R^{e} are each independently hydrogen, a halogen, a hydroxyl group, a cyano group, a nitro group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group.

In Chemical Formula 1A, R^{a}, R^{b}, R^{b}, R^{d}, and R^{e} may each independently be hydrogen, a halogen group, or a substituted or unsubstituted C1 to C10 alkyl group.

The first compound may be represented by any one of Chemical Formulas 1A-1 to 1A-3.

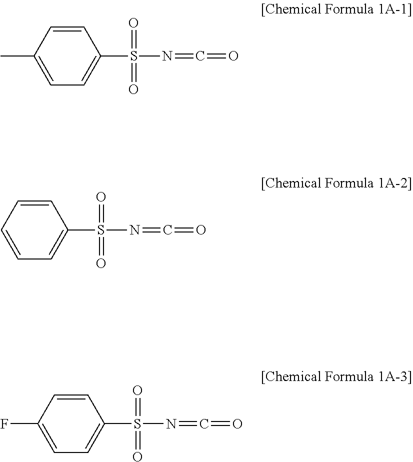

In Chemical Formula 2, one of X¹ and X² may be a fluoro group and the other may be —O—L¹—R¹, wherein L¹ may be a single bond or a substituted or unsubstituted C1 to C10 alkylene group and R¹ may be a cyano group (—CN) or a difluorophosphite group (—OPF₂).

The second compound may be represented by Formula 2-1.

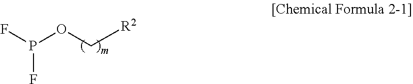

In Chemical Formula 2-1,

m is one of integers ranging from 1 to 5, and

R² is a cyano group (—CN) or a difluorophosphite group (—OPF₂).

In Chemical Formula 2,

X¹ is —O—L²-R³ and X² is —O—L³—R⁴,

wherein L² and L³ are each independently a single bond or a substituted or unsubstituted C1 to C10 alkylene group, and

R³ and R⁴ may each independently be a substituted or unsubstituted C1 to C10 alkyl group, or R³ and R⁴ may be linked to each other to form a substituted or unsubstituted monocyclic aliphatic heterocycle or polycyclic aliphatic heterocycle.

The second compound may be represented by Chemical Formula 2-2.

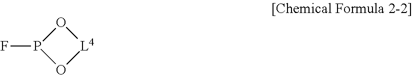

In Chemical Formula 2-2,

L⁴ is a substituted or unsubstituted C2 to C5 alkylene group.

Chemical Formula 2-2 may be represented by Chemical Formula 2-2a or Chemical Formula 2-2b.

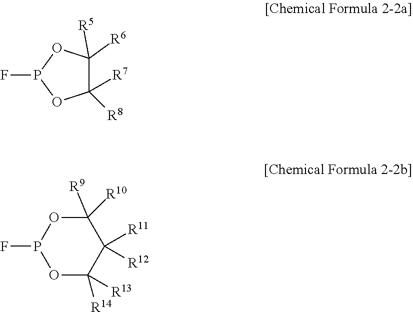

In Chemical Formula 2-2a and Chemical Formula 2-2b,

R⁵ to R¹⁴ are each independently hydrogen, a halogen group, or a substituted or unsubstituted C1 to C5 alkyl group.

Another embodiment of the present invention provides a rechargeable lithium battery including a positive electrode including a positive electrode active material, a negative electrode including a negative electrode active material, and the aforementioned electrolyte for the rechargeable lithium battery.

### Advantageous Effects

Due to the additive with improved thermal safety, it is possible to implement a rechargeable lithium battery having improved high-temperature characteristics and swelling characteristics by suppressing an increase in internal resistance and generation of gas after being left at a high temperature, and by suppressing a voltage drop.

### DESCRIPTION OF THE DRAWINGS

FIG. 1 is a schematic view showing a rechargeable lithium battery according to an embodiment of the present invention.

FIG. 2 is a graph showing room-temperature charge/discharge cycle characteristics of the rechargeable lithium battery cells according to Examples 1 to 8 and Comparative Examples 1 to 6.

### DESCRIPTION OF SYMBOLS

100: rechargeable lithium pouch battery

10: positive electrode

20: negative electrode

30: separator

110: electrode assembly

120: case

130: electrode tab

### MODE FOR INVENTION

Hereinafter, a rechargeable lithium battery according to an embodiment of the present invention will be described in detail with reference to the accompanying drawings. However, these embodiments are exemplary, the present invention is not limited thereto and the present invention is defined by the scope of claims.

In the present specification, unless otherwise defined, “substituted” means that at least one hydrogen in a substituent or compound is deuterium, a cyano group, a halogen group, a hydroxyl group, a nitro group, a C1 to C30 alkyl group, a C3 to C30 cycloalkyl group, a C6 to C30 aryl group, C2 to C30 heteroaryl group, C1 to C20 alkoxy group, C1 to C10 trifluoroalkyl group, or a combination thereof.

In one example of the present invention, “substituted” means that at least one hydrogen in a substituent or compound is substituted with a halogen group, a C1 to C30 alkyl group, or a C6 to C30 aryl group. In addition, in a specific example of the present invention, “substituted” refers to replacement of at least one hydrogen of a substituent or compound is substituted with a halogen group, a C1 to C20 alkyl group, or a C6 to C30 aryl group. In addition, in a specific example of the present invention, “substituted” refers to replacement of at least one hydrogen of a substituent or compound is substituted with a halogen group, a C1 to C5 alkyl group, or a C6 to C18 aryl group. In addition, in specific examples of the present invention, “substituted” refers to replacement of at least one hydrogen of a substituent or compound by fluorine, bromine, chlorine, iodine, methyl, ethyl, propyl, butyl, phenyl, biphenyl, terphenyl or naph means substituted with an ethyl group.

In the present specification, unless otherwise defined, “hetero” refers to one including one to three heteroatoms selected from N, O, S, P, and Si, and remaining carbons in one functional group.

In the present specification, “aryl group” refers to a group including at least one hydrocarbon aromatic moiety, and all the elements of the hydrocarbon aromatic moiety have p-orbitals which form conjugation, for example a phenyl group, a naphthyl group, and the like, two or more hydrocarbon aromatic moieties may be linked by a sigma bond and may be, for example a biphenyl group, a terphenyl group, a quarterphenyl group, and the like, and two or more hydrocarbon aromatic moieties are fused directly or indirectly to provide a non-aromatic fused ring, for example a fluorenyl group.

The aryl group may include a monocyclic, polycyclic or fused ring polycyclic (i.e., rings sharing adjacent pairs of carbon atoms) functional group.

In the present specification, “heterocyclic group” is a generic concept of a heteroaryl group, and may include at least one heteroatom selected from N, O, S, P, and Si instead of carbon (C) in a cyclic compound such as aryl group, a cycloalkyl group, a fused ring thereof, or a combination thereof. When the heterocyclic group is a fused ring, the entire ring or each ring of the heterocyclic group may include one or more heteroatoms.

For example, “heteroaryl group” may refer to aryl group including at least one heteroatom selected from N, O, S, P, and Si. Two or more heteroaryl groups are linked by a sigma bond directly, or when the heteroaryl group includes two or more rings, the two or more rings may be fused. When the heteroaryl group is a fused ring, each ring may include one to three heteroatoms.

More specifically, the substituted or unsubstituted C6 to C30 aryl group may be a substituted or unsubstituted phenyl group, a substituted or unsubstituted naphthyl group, a substituted or unsubstituted anthracenyl group, a substituted or unsubstituted phenanthrenyl group, a substituted or unsubstituted naphthacenyl group, a substituted or unsubstituted pyrenyl group, a substituted or unsubstituted biphenyl group, a substituted or unsubstituted p-terphenyl group, a substituted or unsubstituted m-terphenyl group, a substituted or unsubstituted o-terphenyl group, a substituted or unsubstituted chrysenyl group, a substituted or unsubstituted triphenylene group, a substituted or unsubstituted perylenyl group, a substituted or unsubstituted fluorenyl group, a substituted or unsubstituted indenyl group, a substituted or unsubstituted furanyl group, or a combination thereof, but is not limited thereto.

More specifically, the substituted or unsubstituted C2 to C30 heterocyclic group may be a substituted or unsubstituted thiophenyl group, a substituted or unsubstituted pyrrolyl group, a substituted or unsubstituted pyrazolyl group, a substituted or unsubstituted imidazolyl group, a substituted or unsubstituted triazolyl group, a substituted or unsubstituted oxazolyl group, a substituted or unsubstituted thiazolyl group, a substituted or unsubstituted oxadiazolyl group, a substituted or unsubstituted thiadiazolyl group, a substituted or unsubstituted pyridyl group, a substituted or unsubstituted pyrimidinyl group, a substituted or unsubstituted pyrazinyl group, a substituted or unsubstituted triazinyl group, a substituted or unsubstituted benzofuranyl group, a substituted or unsubstituted benzothiophenyl group, a substituted or unsubstituted benzimidazolyl group, a substituted or unsubstituted indolyl group, a substituted or unsubstituted quinolinyl group, a substituted or unsubstituted isoquinolinyl group, a substituted or unsubstituted quinazolinyl group, a substituted or unsubstituted quinoxalinyl group, a substituted or unsubstituted naphthyridinyl group, a substituted or unsubstituted benzoxazinyl group, a substituted or unsubstituted benzthiazinyl group, a substituted or unsubstituted acridinyl group, a substituted or unsubstituted phenazinyl group, a substituted or unsubstituted phenothiazinyl group, a substituted or unsubstituted phenoxazinyl group, a substituted or unsubstituted carbazolyl group, a substituted or unsubstituted dibenzofuranyl group, or a substituted or unsubstituted dibenzothiophenyl group, or a combination thereof, but is not limited thereto.

A rechargeable lithium battery may be classified into a lithium ion battery, a lithium ion polymer battery, and a lithium polymer battery depending on kinds of a separator and an electrolyte. It also may be classified to be cylindrical, prismatic, coin-type, pouch-type, and the like depending on shape. In addition, it may be bulk type and thin film type depending on sizes. Structures and manufacturing methods for lithium ion batteries pertaining to this disclosure are well known in the art.

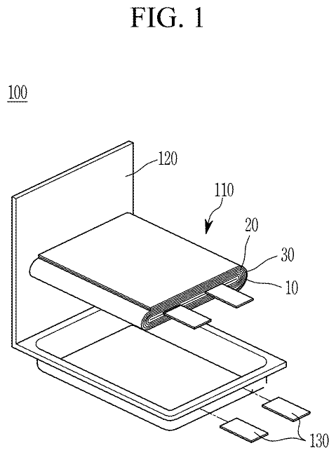

FIG. 1 is an exploded perspective view of a rechargeable lithium battery according to an embodiment. A rechargeable lithium battery according to an embodiment is described as an example of a pouch-type battery, but the present invention is not limited thereto, and may be applied to batteries of various shapes such as a cylindrical shape and a prismatic shape.

Referring to FIG. 1, a rechargeable lithium pouch battery 100 according to an embodiment includes an electrode assembly 110 in which a positive electrode 10 and a negative electrode 20 with a separator 30 interposed therebetween are wound, a case 120 housing the electrode assembly 110, and an electrode tab 130 serving as an electrical passage for inducing the current formed in the electrode assembly 110 to the outside. The two surfaces of the case 120 are sealed by overlapping the surfaces facing each other. In addition, the electrolyte is injected into the case 120 containing the electrode assembly 110, and the positive electrode 10, the negative electrode 20, and the separator 30 may be impregnated with the electrolyte (not shown).

Hereinafter, a more detailed configuration of the rechargeable lithium battery 100 according to an embodiment of the present invention will be described.

A rechargeable lithium battery according to one embodiment of the present invention includes an electrolyte, a positive electrode, and a negative electrode.

The electrolyte includes a non-aqueous organic solvent, a lithium salt, and an additive, wherein the additive is a composition including a first compound represented by Chemical Formula 1 and a second compound represented by Chemical Formula 2.

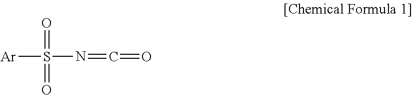

In Chemical Formula 1,

Ar is a substituted or unsubstituted C6 to C30 aryl group or a substituted or unsubstituted C2 to C30 heterocyclic group;

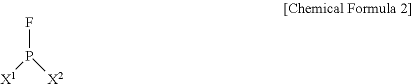

wherein, in Chemical Formula 2,

X¹ and X² are each independently a halogen or —O—L¹—R¹,

at least one of X¹ to X² is —O—L¹—R¹,

wherein L¹ is a single bond or a substituted or unsubstituted C1 to C10 alkylene group, and

R¹s are each independently a cyano group (—CN), a difluorophosphite group (—OPF₂), a substituted or unsubstituted C1 to C10 alkyl group, a substituted or unsubstituted C2 to C10 alkenyl group, a substituted or unsubstituted C2 to C10 alkynyl group, a substituted or unsubstituted C3 to C10 cycloalkyl group, a substituted or unsubstituted C3 to C10 cycloalkenyl group, a substituted or unsubstituted C3 to C10 cycloalkynyl group, or a substituted or unsubstituted C6 to C20 aryl group, and

when X¹ and X² are simultaneously —O—L¹—R¹,

R¹s are each independently present, or

two R¹s are linked to each other to form a substituted or unsubstituted monocyclic or polycyclic aliphatic heterocycle or a substituted or unsubstituted monocyclic or polycyclic aromatic heterocycle.

The first compound represented by Chemical Formula 1 includes an isocyanate functional group, wherein the isocyanate a functional group acts as an anion receptor to induce stable formation of PF₆⁻, thereby, suppressing decomposition of PF₆⁻ on the positive electrode surface and preventing oxidation reaction of the electrolyte, which may occur during high-temperature cycle operation of the rechargeable lithium battery, and resulting in improving high-rate charge and discharge characteristics and swelling characteristics. In addition, the first compound may form a film on the positive electrode surface, suppressing a side reaction of the electrolyte and breakdown of the electrode structure and resultantly, improving performance.

Furthermore, a fluoro phosphite-based compound represented by Chemical Formula 2 may be included therewith to control an adverse effect of decomposition products of lithium salt in the electrolyte, which are generated during the high-temperature decomposition.

In general, lithium salt anions such as hexafluorophosphate anions are decomposed, producing products such as lithium fluoride (LiF) and phosphorus pentafluoride (PF₅), strong Lewis acid. The lithium fluoride increases resistance on the electrode surface, and the phosphorus pentafluoride etches and breaks down pre-formed stable electrode film components.

However, the compound represented by Chemical Formula 2 binds to the phosphorus pentafluoride and stabilizes it to suppress strong acidic characteristics of the phosphorus pentafluoride (PF₅). In addition, this compound traps oxygen gas generated from the breakdown of the positive electrode structure, suppressing an electrolyte combust reaction at a high temperature.

In other words, the composition simultaneously includes the first compound represented by Chemical Formula 1 and the second compound represented by Chemical Formula 2, simultaneously improving high-temperature safety and swelling characteristics of the battery.

For example, the composition may include the first compound and the second compound in a weight ratio of 0.1:1 to 10:1.

As a specific example, the composition may include the first compound and the second compound in a weight ratio of 0.2:1 to 10:1, 0.3:1 to 10:1, 0.4:1 to 10:1, or 0.5:1 to 10:1.

In another specific example, the composition may include the first compound and the second compound in a weight ratio of 0.2:1 to 9:1, 0.2:1 to 8:1, 0.2:1 to 7:1, 0.2:1 to 6:1, or 0.2:1 to 5:1.

For example, the composition may include the first compound and the second compound in a weight ratio of 0.5:1 to 5:1.

In an embodiment, the first compound and the second compound may be included in a weight ratio of 0.5: 1, 1:1, 3:1, or 5:1.

When the mixing ratio of the first compound and the second compound is as described above, a degree of improvement in high-temperature storage characteristics and swelling characteristics may be maximized.

Meanwhile, the first compound may be included in an amount of 0.1 to 5.0 parts by weight, for example, 0.5 to 5.0 parts by weight, based on 100 parts by weight of the electrolyte for the rechargeable lithium battery.

In addition, the second compound may be included in an amount of 0.1 to 5.0 parts by weight, for example, 1.0 to 5.0 parts by weight, based on 100 parts by weight of the electrolyte for the rechargeable lithium battery.

The composition may be included in an amount of 0.2 to 10 parts by weight, for example, 1.0 to 10 parts by weight, based on 100 parts by weight of the electrolyte for the rechargeable lithium battery.

When the content of the composition and the content of each component in the composition are respectively within the ranges, resistance characteristics during the high-temperature storage are improved, gas generation inside the battery is suppressed, realizing a rechargeable lithium battery having improved battery characteristics at room temperature and a high temperature and in addition, improved swelling characteristics.

For example, the first compound may be represented by Chemical Formula 1A.

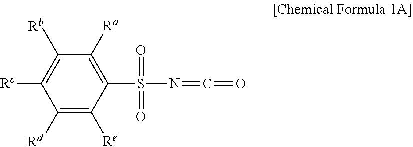

R^{a}, R^{b}, R^{b}, R^{d}, and R^{e} are each independently hydrogen, a halogen, a hydroxyl group, a cyano group, a nitro group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group.

In Chemical Formula 1A, R^{a}, R^{b}, R^{b}, R^{d}, and R^{e} may each independently be hydrogen, a halogen group, or a substituted or unsubstituted C1 to C10 alkyl group.

As a specific example, the first compound may be represented by any one of Chemical Formulas 1A-1 to 1A-3.

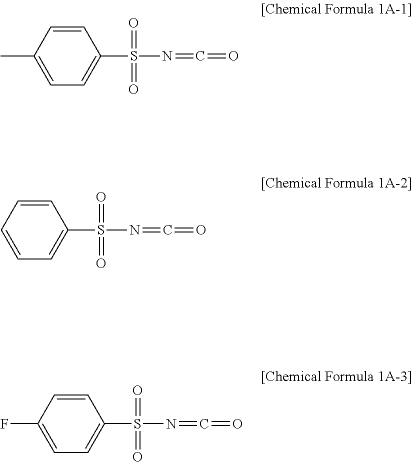

For example, one of X¹ and X² in Chemical Formula 2 is a fluoro group, and the other is —O—L¹—R¹,

wherein L¹ may be a single bond or a substituted or unsubstituted C1 to C10 alkylene group, and

R¹ may be a cyano group (—CN) or a difluorophosphite group (—OPF₂).

As a specific example, the second compound may be represented by Chemical Formula 2-1.

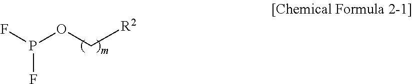

In Chemical Formula 2-1,

m is one of integers ranging from 1 to 5,

R² is a cyano group (—CN) or a difluorophosphite group (—OPF₂).

For example, in Chemical Formula 2, X¹ is —O—L²—R³, X² is —O—L³-R⁴, L² and L³ are each independently a single-bonded or substituted or unsubstituted C1 to C10 alkylene group, R³ and R⁴ are each independently a substituted or unsubstituted C1 to C10 alkyl group, wherein R³ and R⁴ may be linked to each other to form a substituted or unsubstituted monocyclic aliphatic heterocycle or a polycyclic aliphatic heterocycle.

As a specific example, the second compound may be represented by Chemical Formula 2-2.

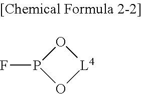

In Chemical Formula 2-2,

L⁴ is a substituted or unsubstituted C2 to C5 alkylene group.

As a more specific example, Chemical Formula 2-2 may be represented by Chemical Formula 2-2a or Chemical Formula 2-2b.

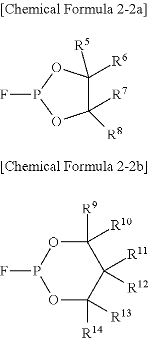

In Chemical Formula 2-2a and Chemical Formula 2-2b,

R⁵ to R¹⁴ are each independently hydrogen, a halogen group, or a substituted or unsubstituted C1 to C5 alkyl group.

For example, the second compound may be any one selected from the compounds listed in Group 1.

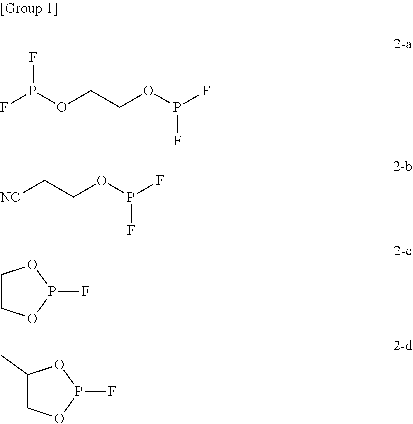

The non-aqueous organic solvent serves as a medium for transmitting ions taking part in the electrochemical reaction of a battery.

The non-aqueous organic solvent serves as a medium for transmitting ions taking part in the electrochemical reaction of a battery.

The carbonate-based solvent may be dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and the like. The ester-based solvent may be methyl acetate, ethyl acetate, n-propyl acetate, t-butyl acetate, methyl propionate, ethyl propionate, propyl propionate, decanolide, mevalonolactone, caprolactone, and the like. The ether-based solvent may be dibutyl ether, tetraglyme, diglyme, dimethoxyethane, 2-methyltetrahydrofuran, tetrahydrofuran, and the like. In addition, the ketone-based solvent may be cyclohexanone, and the like. The alcohol-based solvent may include ethanol, isopropyl alcohol, and the like, and the aprotic solvent may include nitriles such as R¹⁸—CN (wherein R¹⁸ is a hydrocarbon group having a C2 to C20 linear, branched, or cyclic structure and may include a double bond, an aromatic ring, or an ether bond), and the like, amides such as dimethyl formamide, and the like, dioxolanes such as 1,3-dioxolane, and the like, sulfolanes, and the like.

The non-aqueous organic solvent may be used alone or in a mixture, and when used in a mixture, the mixing ratio may be appropriately adjusted in accordance with a desired battery performance, which is widely understood by those skilled in the art.

The carbonate-based solvent is prepared by mixing a cyclic carbonate and a chain carbonate. When the cyclic carbonate and chain carbonate are mixed together in a volume ratio of 1:9 to 9:1, a performance of the electrolyte may be improved.

In particular, in an embodiment, the non-aqueous organic solvent may include the cyclic carbonate and the chain carbonate in a volume ratio of 2:8 to 5:5, and as a specific example, the cyclic carbonate and the chain carbonate may be included in a volume ratio of 2:8 to 4:6.

More specifically, the cyclic carbonate and the chain carbonate may be included in a volume ratio of 2:8 to 3:7.

The non-aqueous organic solvent may further include an aromatic hydrocarbon-based organic solvent in addition to the carbonate-based solvent. Herein, the carbonate-based solvent and the aromatic hydrocarbon-based organic solvent may be mixed in a volume ratio of 1:1 to 30:1.

The aromatic hydrocarbon-based organic solvent may be an aromatic hydrocarbon-based compound of Chemical Formula 3.

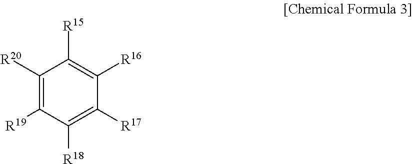

In Chemical Formula 3, R¹⁵ to R²⁰ are the same or different and are hydrogen, a halogen, a C1 to C10 alkyl group, a haloalkyl group, or a combination thereof.

Specific examples of the aromatic hydrocarbon-based organic solvent may be benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

The electrolyte may further include vinylene carbonate, vinyl ethylene carbonate, or an ethylene carbonate-based compound represented by Chemical Formula 4 as an additive to improve cycle-life of a battery.

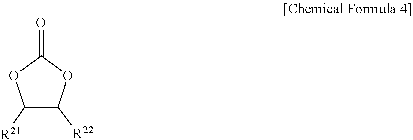

In Chemical Formula 4, R²¹ and R²² are the same or different, and are selected from hydrogen, a halogen, a cyano group (CN), a nitro group (NO₂), and a fluorinated C1 to C5 alkyl group, provided that at least one of R²¹ and R²² is selected from a halogen, a cyano group (CN), a nitro group (NO₂), and a fluorinated C1 to C5 alkyl group, and both R²¹ and R²² are not hydrogen.

Examples of the ethylene carbonate-based compound may include difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. When such an additive for improving cycle-life is further used, its amount may be appropriately adjusted.

The lithium salt dissolved in the non-organic solvent supplies lithium ions in a battery, enables a basic operation of a rechargeable lithium battery, and improves transportation of the lithium ions between positive and negative electrodes. Examples of the lithium salt may include one or more selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiC₄F₉SO₃, LiClO₄, LiAlO₂, LiAlCl₄, LiPO₂F₂, LiN(CₓF₂ₓ₊₁SO₂)(C_{y}F_{2y+1}SO₂) (wherein x and y are natural numbers, for example an integer of 1 to 20), LiCl, LiI, LiB(C₂O₄)2 (lithium bis(oxalato) borate: LiBOB), LiDFOB (lithium difluoro(oxalato)borate), and Li[PF₂(C₂O₄)₂] (lithium difluoro (bis oxalato) phosphate). The lithium salt may be used in a concentration ranging from 0.1 M to 2.0 M. When the lithium salt is included at the above concentration range, an electrolyte may have excellent performance and lithium ion mobility due to optimal electrolyte conductivity and viscosity.

The positive electrode includes a positive electrode current collector and a positive electrode active material layer on the positive electrode current collector, and the positive electrode active material layer includes a positive electrode active material.

The positive electrode active material may include lithiated intercalation compounds that reversibly intercalate and deintercalate lithium ions.

Specifically, one or more of a composite oxide of a metal selected from cobalt, manganese, nickel, and a combination thereof and lithium may be used.

Of course, one having a coating layer on the surface of the lithium composite oxide may be used, or a mixture of the composite oxide and a compound having a coating layer may be used. The coating layer may include one or more coating element compound selected from an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating process may include any conventional processes as long as it does not cause any side effects on the properties of the positive electrode active material (e.g., inkjet coating, dipping), which is well known to persons having ordinary skill in this art, so a detailed description thereof is omitted. The positive electrode active material may be, for example, one or more of lithium composite oxides represented by Chemical Formula 5.

LiₓM¹_{1-y-z}M²_{y}M³_{z}O₂ [Chemical Formula 5]

In Chemical Formula 5,

0.5≤x≤1.8, 0≤y≤1, 0≤z≤1, 0≤y+z<1, and M¹, M², and M³ are each independently any one selected from a metal such as Ni, Co, Mn, Al, Sr, Mg, or La, and a combination thereof.

In an embodiment, M¹ may be a metal such as Co, Mn, Al, Sr, Mg, or La, and M² and M³ may each independently be Ni or Co.

In a specific embodiment, M¹ may be Mn or Al, and M² and M³ may each independently be Ni or Co, but they are not limited thereto.

A content of the positive electrode active material may be 90 wt % to 98 wt % based on the total weight of the positive electrode active material layer.

In an embodiment of the present invention, the positive electrode active material layer may optionally include a conductive material and a binder. In this case, a content of the conductive material and the binder may be 1 wt % to 5 wt %, respectively, based on the total weight of the positive electrode active material layer.

The conductive material is included to impart conductivity to the positive electrode and any electrically conductive material may be used as a conductive material unless it causes a chemical change in the configured battery. Examples of the conductive material may include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

The binder improves binding properties of positive electrode active material particles with one another and with a current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but is not limited thereto.

The positive electrode current collector may include Al, but is not limited thereto.

The negative electrode includes a negative electrode current collector and a negative electrode active material layer including a negative electrode active material formed on the negative electrode current collector.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions includes carbon materials. The carbon material may be any generally-used carbon-based negative electrode active material in a rechargeable lithium battery and examples of the carbon material include crystalline carbon, amorphous carbon, and a combination thereof. The crystalline carbon may be non-shaped, or sheet, flake, spherical, or fiber shaped natural graphite or artificial graphite and the amorphous carbon may be a soft carbon, a hard carbon, a mesophase pitch carbonization product, calcined coke, and the like.

The lithium metal alloy may include lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be Si, Si—C composite, SiOₓ (0<x<2), a Si—Q alloy wherein Q is an element selected from an alkali metal, an alkaline-earth metal, a Group 13 element, a Group 14 element, a Group 15 element, a Group 16 element, a transition metal, a rare earth element, and a combination thereof, but not Si), Sn, SnO₂, a Sn—R²² alloy (wherein R²² is an element selected from an alkali metal, an alkaline-earth metal, a Group 13 element, a Group 14 element, a Group 15 element, a Group 16 element, a transition metal, a rare earth element, and a combination thereof, but not Sn), and the like. One or more of these materials may be mixed with SiO₂.

The elements Q and R²² may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

The transition metal oxide may be a vanadium oxide, a lithium vanadium oxide, and the like.

In the negative electrode active material layer, the negative electrode active material may be included in an amount of 95 wt % to 99 wt % based on the total weight of the negative electrode active material layer.

In an embodiment, the negative electrode active material layer may include a binder, and optionally a conductive material. The content of the binder in the negative electrode active material layer may be 1 wt % to 5 wt % based on the total weight of the negative electrode active material layer. In addition, when the conductive material is further included, 90 wt % to 98 wt % of the negative electrode active material, 1 wt % to 5 wt % of the binder, and 1 wt % to 5 wt % of the conductive material may be used.

The binder improves binding properties of negative electrode active material particles with one another and with a current collector. The binder may be a non-water-soluble binder, a water-soluble binder, or a combination thereof.

The non-water-soluble binder may be polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The water-soluble binder may be a rubber-based binder or a polymer resin binder. The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof. The polymer resin binder may be selected from polytetrafluoroethylene, ethylenepropyleneco polymer, polyethylene oxide, polyvinylpyrrolidone, polyepichlorohydrine, polyphosphazene, polyacrylonitrile, polystyrene, an ethylene propylene diene copolymer, polyvinylpyridine, chlorosulfonated polyethylene, latex, a polyester resin, an acrylic resin, a phenolic resin, an epoxy resin, polyvinyl alcohol, or a combination thereof.

When the water-soluble binder is used as a negative electrode binder, a cellulose-based compound may be further used to provide viscosity as a thickener. The cellulose-based compound includes one or more of carboxymethyl cellulose, hydroxypropylmethyl cellulose, methyl cellulose, or alkali metal salts thereof. The alkali metals may be Na, K, or Li. Such a thickener may be included in an amount of 0.1 parts by weight to 3 parts by weight based on 100 parts by weight of the negative electrode active material.

The conductive material is included to improve electrode conductivity and any electrically conductive material may be used as a conductive material unless it causes a chemical change. Examples of the conductive material include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

The negative electrode current collector may be selected from a copper foil, a nickel foil, a stainless-steel foil, a titanium foil, a nickel foam, a copper foam, a polymer substrate coated with a conductive metal, and a combination thereof.

The rechargeable lithium battery may further include a separator between the negative electrode and the positive electrode, depending on a type of the battery. Such a separator may be a porous substrate or a composite porous substrate.

The porous substrate may be a substrate including pores, and lithium ions may move through the pores. The porous substrate may for example include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

The composite porous substrate may have a form including a porous substrate and a functional layer on the porous substrate. The functional layer may be, for example, one or more of a heat-resistant layer and an adhesive layer from the viewpoint of enabling additional function. For example, the heat-resistant layer may include a heat-resistant resin and optionally a filler.

In addition, the adhesive layer may include an adhesive resin and optionally a filler.

The filler may be an organic filler or an inorganic filler.

### DETAILED DESCRIPTION OF THE EMBODIMENTS

Hereinafter, examples of the present invention and comparative examples are described. These examples, however, are not in any sense to be interpreted as limiting the scope of the invention.

### Manufacture of Rechargeable Lithium Battery Cells

### Comparative Example 1

LiCoO₂ as a positive electrode active material, polyvinylidene fluoride as a binder, and ketjen black as a conductive material were mixed in a weight ratio of 97:2:1 and then, dispersed in N-methyl pyrrolidone, preparing positive electrode active material slurry.

The positive electrode active material slurry was coated on a 14 μm-thick Al foil, dried at 110° C., and pressed, manufacturing a positive electrode.

A negative electrode active material slurry was prepared by mixing artificial graphite as a negative electrode active material, a styrene-butadiene rubber as a binder, and carboxymethylcellulose as a thickener in a weight ratio of 97:1:2, respectively, and dispersing it in distilled water.

The negative electrode active material slurry was coated on a 10 μm-thick Cu and then, dried at 100° C. and pressed, manufacturing a negative electrode.

The positive electrode and the negative electrode were assembled with a 25 μm-thick polyethylene separator to manufacture an electrode assembly, and an electrolyte was injected thereinto, manufacturing a rechargeable lithium battery cell.

The electrolyte has a composition as follows.

(Composition of Electrolyte)

Salt: 1.5 M LiPF₆

Solvent: ethylene carbonate:propylene carbonate:ethyl propionate:propyl propionate (EC:PC:EP:PP=a volume ratio of 10:15:30:45)

### Comparative Example 2

A rechargeable lithium battery cell was manufactured in the same manner as in Comparative Example 1, except that 1.0 part by weight of p-toluene sulfonyl isocyanate represented by Chemical Formula 1A-1 was added to the electrolyte.

(However, in the electrolyte composition, “parts by weight” means the relative weight of the additive to 100 weight of the total electrolyte (lithium salt+non-aqueous organic solvent).)

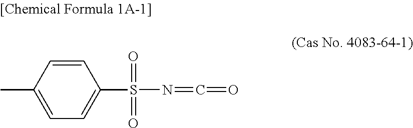

### Comparative Example 3

A rechargeable lithium battery cell was manufactured in the same manner as in Comparative Example 1, except that 1.0 part by weight of the compound represented by Chemical Formula 2-a was added to the electrolyte.

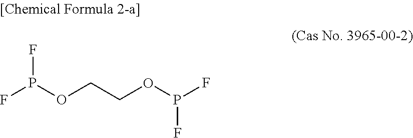

### Comparative Example 4

A rechargeable lithium battery cell was manufactured in the same manner as in Comparative Example 1, except that 1.0 part by weight of the compound represented by Chemical Formula 2-d was added to the electrolyte.

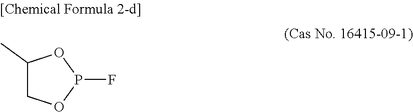

### Comparative Example 5

A rechargeable lithium battery cell was manufactured in the same manner as in Comparative Example 1, except that 1.0 part by weight of p-toluene sulfonyl isocyanate represented by Chemical Formula 1A-1 and 1.0 parts by weight of tris(trimethylsilyl) phosphate represented by Chemical Formula i were added to the electrolyte.

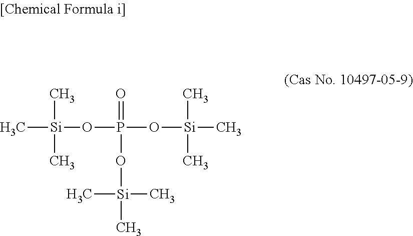

### Comparative Example 6

A rechargeable lithium battery cell was manufactured in the same manner as in Comparative Example 1, except that 1.0 part by weight of p-toluenesulfonyl cyanide represented by Chemical Formula ii and 1.0 part by weight of the compound represented by Chemical Formula 2-a were added to the electrolyte.

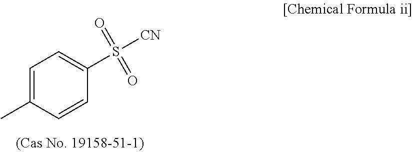

### Example 1

A rechargeable lithium battery cell was manufactured in the same manner as in Comparative Example 1, except that 0.5 parts by weight of p-toluene sulfonyl isocyanate represented by Chemical Formula 1A-1 and 1.0 part by weight of the compound represented by Chemical Formula 2-a were added to the electrolyte.

### Examples 2 to 8

Rechargeable lithium battery cells were manufactured in the same manner as in Example 1, except that the composition was changed into each composition shown in Table 1.

The compositions according to the examples and the comparative examples are shown in Table 1.

TABLE 1

| | Additive composition | |
|---|---|---|
| | Chemical Formula 1 | Chemical Formula 2 |
| | (parts by weight) | (parts by weight) |
| Comparative | — | — |
| Example 1 | | |
| Comparative | Chemical Formula 1A-1 (1.0) | — |
| Example 2 | | |
| Comparative | — | Chemical Formula 2-a (1.0) |
| Example 3 | | |
| Comparative | — | Chemical Formula 2-d (1.0) |
| Example 4 | | |
| Comparative | Chemical Formula 1A-1 (1.0) | Chemical Formula i (1.0) |
| Example 5 | | |
| Comparative | Chemical Formula ii (1.0) | Chemical Formula 2-a (1.0) |
| Example 6 | | |
| Example 1 | Chemical Formula 1A-1 0.5 | Chemical Formula 2-a (1.0) |
| Example 2 | Chemical Formula 1A-1 (1.0) | Chemical Formula 2-a (1.0) |
| Example 3 | Chemical Formula 1A-1 (3.0) | Chemical Formula 2-a (1.0) |
| Example 4 | Chemical Formula 1A-1 (5.0) | Chemical Formula 2-a (1.0) |
| Example 5 | Chemical Formula 1A-1 (0.5) | Chemical Formula 2-d (1.0) |
| Example 6 | Chemical Formula 1A-1 (1.0) | Chemical Formula 2-d (1.0) |
| Example 7 | Chemical Formula 1A-1 (3.0) | Chemical Formula 2-d (1.0) |
| Example 8 | Chemical Formula 1A-1 (5.0) | Chemical Formula 2-d (1.0) |

### Evaluation 1: Evaluation of Swelling Characteristics

The rechargeable lithium battery cells according to Examples 1 to 8 and Comparative Examples 1 to 6 were constant current-constant voltage charged under conditions of 0.7 C, 4.4 V, and 0.05 C cut-off. After the charging, the cells were measured with respect to a thickness and then, allowed to stand at 60° C. for 28 days and remeasured with respect to a thickness by every 7 days to calculate a thickness variation ratio (%). The thickness variation ratios at the 28^{th} day are shown in Table 2.

Evaluation 2: Evaluation of DC Resistance Increase Rate after High-Temperature Storage

The rechargeable lithium battery cells according to Examples 1 to 8 and Comparative Examples 1 to 6 were measured with respect to initial DC resistance (DCIR) as AV/AI (change in voltage/change in current), and after changing a maximum energy state inside the battery cells into a full charge state (SOC 100%) and storing the cells in this state at a high temperature (60° C.) for 30 days, the cells was measured with respect to DC resistance to calculate a DCIR increase rate (%) according to Equation 1, and the results are shown in Table 2.

DCIR increase rate=(DCIR after 30 days/Initial DCIR)×100%[Equation 1]

### Evaluation 3: Evaluation of High-Temperature Charge/Discharge Characteristics

The rechargeable lithium battery cells according to Examples 1 to 8 and Comparative Examples 1 to 6 were once charged and discharged at 0.2 C and measured with respect to charge and discharge capacity (before high temperature storage).

In addition, the rechargeable lithium battery cells according to Examples 1 to 8 and Comparative Examples 1 to 6 were charged to SOC100% (a state of charge to 100% of a total charge capacity), stored at 60° C. for 30 days, and discharged at 0.2 C to 3.0 V under a constant current and then, measured with respect to discharge capacity. Charge and discharge characteristics at this time are called to be capacity retention (%), which was obtained by calculating a discharge capacity ratio of the discharge capacity to the initial capacity, and the results are shown in Table 2.

The cells were recharged to 4.4 V at 0.2 C under a constant current, cut off at 0.05 C, and discharged to 3.0 V at 0.2 C under the constant current and then, measured with respect to discharge capacity. Charge and discharge characteristics at this time are called to be recovery characteristics. In general, storage characteristics at a high temperature mean recovery characteristics. Herein, charge and discharge capacity at this time was measured to calculate a ratio of the discharge capacity to the initial capacity, which is shown as a capacity recovery rate (%) in Table 2.

TABLE 2

| | | DC resistance | Capacity | Capacity |
|---|---|---|---|---|
| | | increase rate | retention | recovery |
| | Thickness | after high- | rate | rate |
| | increase | temperature | (%, | (%, |
| | rate (%) | storage (%) | retention) | recovery) |
| Comparative | 17.0 | 142.0 | 83.0 | 90.2 |
| Example 1 | | | | |
| Comparative | 15.0 | 137.0 | 86.0 | 91.5 |
| Example 2 | | | | |
| Comparative | 14.0 | 136.5 | 85.2 | 91.3 |
| Example 3 | | | | |
| Comparative | 13.4 | 137.2 | 85.7 | 91.1 |
| Example 4 | | | | |
| Comparative | 16.0 | 141.0 | 86.5 | 91.4 |
| Example 5 | | | | |
| Comparative | 16.5 | 140.0 | 86.3 | 91.3 |
| Example 6 | | | | |
| Example 1 | 11.0 | 134.0 | 88.0 | 94.0 |
| Example 2 | 6.5 | 122.0 | 95.0 | 93.8 |
| Example 3 | 7.1 | 126.0 | 92.5 | 93.5 |
| Example 4 | 7.7 | 128.0 | 91.0 | 93.6 |
| Example 5 | 9.0 | 133.0 | 87.0 | 93.9 |
| Example 6 | 6.3 | 123.0 | 94.7 | 93.7 |
| Example 7 | 6.9 | 129.0 | 93.0 | 93.4 |
| Example 8 | 7.2 | 130.0 | 91.0 | 93.6 |

Referring to Table 2, the rechargeable lithium battery cells according to Examples 1 to 8 maintained a lower thickness increase rate than the cells according to Comparative Examples 1 to 6 and thus exhibited excellent swelling characteristics.

In addition, the rechargeable lithium battery cells according to Examples 1 to 8 maintained a lower DC resistance increase rate than the cells according to Comparative Examples 1 to 6 and thus exhibited improved resistance characteristics after stored at a high temperature.

In addition, the rechargeable lithium battery cells according to Examples 1 to 8 exhibited excellent capacity retention and capacity recovery, compared with the rechargeable lithium battery cells according to Comparative Examples 1 to 6.

In summary, the rechargeable lithium battery cells according to Examples 1 to 8 exhibited excellent swelling characteristics and excellent resistance characteristics and charge/discharge characteristics after stored at a high temperature, compared with the cells according to Comparative Examples 1 to 6.

Evaluation 4: Evaluation of Room-Temperature Cycle-Life Characteristics The rechargeable lithium battery cells according to Examples 1 to 8 and

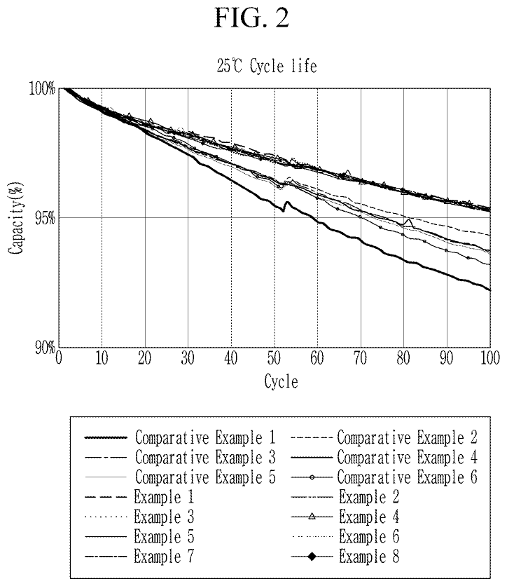

Comparative Examples 1 to 6 were measured with respect to a change in discharge capacity, while 100 cycled charged and discharged within 2.75 V to 4.4 V at a C-rate of 0.5 C at room temperature (25° C.), to calculate a ratio of capacity at the 100^{th} cycles to discharge capacity at the 1^{st} cycle (capacity retention), and the results are shown in FIG. 2.

FIG. 2 is a graph showing room-temperature charge/discharge cycle characteristics of the rechargeable lithium battery cells according to Examples 1 to 8 and Comparative Examples 1 to 6.

Referring to FIG. 2, the cells according to Example 1 to 8, compared with the cells according to Comparative Examples 1 to 6, exhibited not much deteriorated cycle-life.

Accordingly, a rechargeable lithium battery cell using a composition of a specific combination according to the present example embodiment as an additive turned out to significantly improve excellent swelling characteristics and storage characteristics at a high temperature without deteriorating a cycle-life.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

1. An electrolyte for a rechargeable lithium battery, comprising
a non-aqueous organic solvent,
a lithium salt, and
an additive,
wherein the additive is a composition including a first compound represented by Chemical Formula 1 and a second compound represented by Chemical Formula 2: 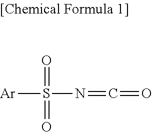
wherein, in Chemical Formula 1,
Ar is a substituted or unsubstituted C6 to C30 aryl group or a substituted or unsubstituted C2 to C30 heterocyclic group; 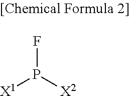
wherein, in Chemical Formula 2,
X¹ and X² are each independently a halogen or —O—L¹—R¹,
at least one of X¹ to X² is —O—L¹—R¹,
wherein L¹ is a single bond or a substituted or unsubstituted C1 to C10 alkylene group, and
R¹s are each independently a cyano group (—CN), a difluorophosphite group (—OPF₂), a substituted or unsubstituted C1 to C10 alkyl group, a substituted or unsubstituted C2 to C10 alkenyl group, a substituted or unsubstituted C2 to C10 alkynyl group, a substituted or unsubstituted C3 to C10 cycloalkyl group, a substituted or unsubstituted C3 to C10 cycloalkenyl group, a substituted or unsubstituted C3 to C10 cycloalkynyl group, or a substituted or unsubstituted C6 to C20 aryl group, and
when X¹ and X² are simultaneously —O—L¹—R¹,
R¹s are each independently present, or
two R¹s are linked to each other to form a substituted or unsubstituted monocyclic or polycyclic aliphatic heterocycle or a substituted or unsubstituted monocyclic or polycyclic aromatic heterocycle.

2. The electrolyte for the rechargeable lithium battery of claim 1, wherein
the composition includes the first compound and the second compound in a weight ratio of 0.1:1 to 10:1.

3. The electrolyte for the rechargeable lithium battery of claim 1, wherein
the composition includes the first compound and the second compound in a weight ratio of 0.5:1 to 5:1.

4. The electrolyte for the rechargeable lithium battery of claim 1, wherein
the first compound is included in an amount of 0.1 to 5.0 parts by weight based on 100 parts by weight of the electrolyte for the rechargeable lithium battery.

5. The electrolyte for the rechargeable lithium battery of claim 1, wherein
the second compound is included in an amount of 0.1 to 5.0 parts by weight based on 100 parts by weight of the electrolyte for the rechargeable lithium battery.

6. The electrolyte for the rechargeable lithium battery of claim 1, wherein
the composition is included in an amount of 0.2 to 10 parts by weight based on 100 parts by weight of the electrolyte for the rechargeable lithium battery.

7. The electrolyte for the rechargeable lithium battery of claim 1, wherein
the first compound is represented by Chemical Formula 1A: 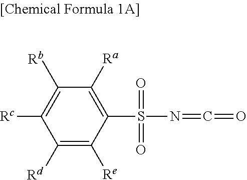
wherein, in Chemical Formula 1A,
R^{a}, R^{b}, R^{b}, R^{d}, and R^{e} are each independently hydrogen, a halogen, a hydroxyl group, a cyano group, a nitro group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group.

8. The electrolyte for the rechargeable lithium battery of claim 7, wherein
in Chemical Formula 1A, R^{a}, R^{b}, R^{b}, R^{d}, and R^{e} are each independently hydrogen, a halogen, or a substituted or unsubstituted C1 to C10 alkyl group.

9. The electrolyte for the rechargeable lithium battery of claim 1, wherein
the first compound is represented by any one of Chemical Formulas 1A-1 to 1A-3:

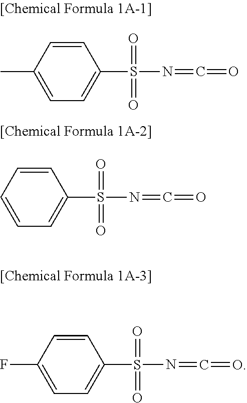

10. The electrolyte for the rechargeable lithium battery of claim 1, wherein
one of X¹ and X² in Chemical Formula 2 is a fluoro group and the other is —O—L¹—R¹
wherein L¹ is a single bond or a substituted or unsubstituted C1 to C10 alkylene group, and
R¹ is a cyano group (—CN) or a difluorophosphite group (—OPF₂).

11. The electrolyte for the rechargeable lithium battery of claim 1, wherein
the second compound is represented by Chemical Formula 2-1: 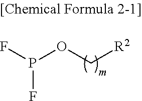
wherein, in Chemical Formula 2-1,
m is one of integers ranging from 1 to 5, and
R² is a cyano group (—CN) or a difluorophosphite group (—OPF₂).

12. The electrolyte for the rechargeable lithium battery of claim 1, wherein
in Chemical Formula 2, X¹ is —O—L²—R³, and X² is —O—L³-R⁴,
wherein L² and L³ are each independently a single bond or a substituted or unsubstituted C1 to C10 alkylene group,
R³ and R⁴ are each independently a substituted or unsubstituted C1 to C10 alkyl group, or R³ and R⁴ are linked to each other to form a substituted or unsubstituted monocyclic aliphatic heterocycle or polycyclic aliphatic heterocycle.

13. The electrolyte for the rechargeable lithium battery of claim 1, wherein
the second compound is represented by Chemical Formula 2-2: 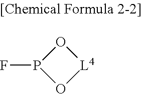
wherein, in Chemical Formula 2-2, L⁴ is a substituted or unsubstituted C2 to C5 alkylene group.

14. The electrolyte for the rechargeable lithium battery of claim 13, wherein
Chemical Formula 2-2 is represented by Chemical Formula 2-2a or Chemical Formula 2-2b: 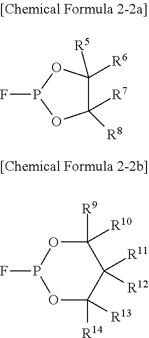
wherein, in Chemical Formula 2-2a and Chemical Formula 2-2b,
R⁵ to R¹⁴ are each independently hydrogen, a halogen group, or a substituted or unsubstituted C1 to C5 alkyl group.

15. The electrolyte for the rechargeable lithium battery of claim 1, wherein
the second compound is any one selected from the compounds listed in Group 1:

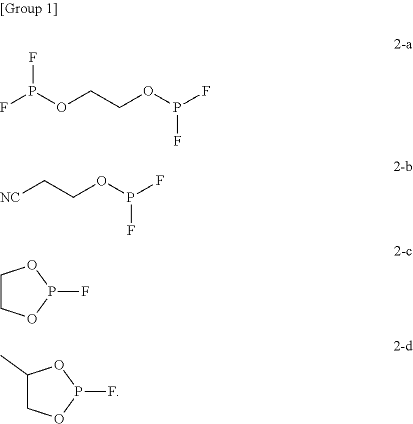

16. A rechargeable lithium battery comprising
a positive electrode including a positive electrode active material;
a negative electrode including a negative electrode active material; and
the electrolyte for the rechargeable lithium battery of claim 1.
